(19) United States
(12) Patent Application Publication
(10) Pub. No.: US 2024/0409407 A1
(43) Pub. Date: Dec. 12, 2024

(54) THERMOCHEMICAL PROCESS AND COMPACT APPARATUS FOR THE CONCENTRATION OF OXYGEN IN EXTRATERRESTRIAL ATMOSPHERES

(71) Applicant: Deutsches Zentrum Für Luft- Und Raumfahrt E.V., Bonn (DE)

(72) Inventors: Josua VIETEN, Köln (DE); Dorottya KRIECHBAUMER, Köln (DE); Lena KLAAS, Köln (DE); Martin ROEB, Köln (DE)

(21) Appl. No.: 18/685,317

(22) PCT Filed: Aug. 23, 2022
(86) PCT No.: PCT/EP2022/073453

§ 371 Date: Aug. 19, 2024

(30) Foreign Application Priority Data
Aug. 24, 2021 (DE) 10 2021 121 911.6

(51) Int. Cl. C01B 13/08; C01B 13/02

(52) U.S. Cl. CPC C01B 13/08; C01B 13/0237; C01B 13/024; C01B 2210/0004; C01B 2210/0006

(57) ABSTRACT

The invention relates to a process for the concentration of oxygen in extraterrestrial atmospheres having low oxygen concentrations, using a thermochemical cyclic process.

### CROSS-REFERENCED TO RELATED APPLICATION(S)

This application is a U.S. National Stage Entry under 35 U.S.C. 371 of International Application No. PCT/EP2022/073453, filed Aug. 23, 2022, which claims priority to DE 10 2021 121911.6 filed on Aug. 24, 2021, the contents of which are incorporated herein by reference in their entireties.

### FIELD OF THE INVENTION

The present invention relates to a process for concentrating oxygen in extraterrestrial atmospheres having a low oxygen concentration using a thermochemical cycle.

### BACKGROUND OF THE INVENTION

The production of oxygen outside the earth's atmosphere is a critical factor for future manned space missions. The return of astronauts to earth requires large amounts of fuel and usually oxygen as an oxidant for corresponding rocket engines. In addition, manned missions require oxygen for life support and optionally for scientific experiments.

Presumably, the first manned space mission outside the earth's system will go to the planet Mars, and will be undertaken in the 2020's to 2030's. Among others, corresponding missions are being planned by the NASA and by the company SpaceX. Both organizations plan the production of oxygen in situ on Mars in an unmanned mission, which is to precede the manned mission. In addition, the production of oxygen on Mars may be necessary already for the unmanned return of samples from Mars to earth (Mars Sample Return).

The company SpaceX plans to produce hydrogen and oxygen on Mars by mining water ice and electrolysing the water with electric current generated from solar energy. Then, the hydrogen is supposed to be reacted with carbon dioxide from the Martian atmosphere to form methane in a Sabatier process, while the oxygen is stored as an oxidant for the return flight [presentation by Elon Musk of Sep. 29, 2017, at the 68th International Astronautical Congress in Adelaide, Australia, Fuel Production from 33:50,_https://www.youtube.com/watch?v=tdUX3ypDVwI].

The U.S. space agency NASA plans to produce oxygen on Mars by electrolyzing CO₂ from the atmosphere of Mars. CO₂ will then be cleaved into O₂ and CO by the electric potential. This process is currently being tested on board of the Mars rover Perseverance within the scope of the MOXIE experiment [M. Hecht, J. Hoffman, D. Rapp, J. McClean, J. SooHoo, R. Schaefer, A. Aboobaker, J. Mellstrom, J. Hartvigsen, F. Meyen, E. Hinterman: Mars Oxygen ISRU Experiment (MOXIE). In: Space Science Reviews. 217, No. 1, Jan. 6, 2021]. On Apr. 20, 2021, the production of 5.37 g of oxygen from the Martian atmosphere was achieved for the first time within one hour [NASA press release, Apr. 21, 2021, https://www.nasa.gov/press-release/nasa-s-perseverance-mars-rover-extracts-first-oxygen-from-red-planet].

In a later mission, a scaled-up version of the MOXIE instrument having a mass of about one metric ton is intended to produce at least 2 kg of O₂/h.

There are other methods for producing oxygen in addition to the electrolysis of CO₂. Technologies for the thermochemical air separation have been developed in recent years at the DLR's Institutes for Solar Research and Future Fuels. The main focus was on the production of oxygen, and the removal of oxygen in the reduction of metal oxides in thermochemical methods for water cleavage and CO₂ cleavage, and the storage of oxygen (oxygen pump) [J. Vieten, B. Bulfin, F. Call, M. Lange, M. Schmücker, A. Francke, M. Roeb, C. Sattler: Perovskite oxides for application in thermochemical air separation and oxygen storage. In: J. Mater. Chem. A, 4, 13652-13659, 2016]. Such systems may also be employed for the production or concentration of oxygen [J. Felinks, M. Lange, F. Call, Patent Application DE102013209658A1].

The underlying chemical method is based on the temperature-dependent chemical potential of oxygen on multivalent metal oxides. Such metal oxides in an oxidized state MOₒₓ, for example, perovskites or cobalt oxides, release oxygen in a thermodynamic equilibrium when the temperature is increased and/or the oxygen partial pressure is lowered, being reduced to the reduced state MO_{red}:

MOₒₓ→MO_{red}+O₂ (1)

Then, at a lower temperature and/or under a higher oxygen partial pressure, the reduced metal oxide can absorb oxygen again, and is thus re-oxidized:

MO_{red}+O₂→MOₒₓ (2)

The temperature of the oxidation step is typically from 250 to 600° C., and the reduction step is performed at 500 to 1000° C.

Thus, overall, the metal oxide is not consumed and serves as a reversible oxygen carrier. The oxygen partial pressure does not need be the same for the oxidation and reduction. Thus, for example, oxygen may be removed from the air, and highly pure nitrogen may be recovered for ammonia production (see DLR projects CaFeLaTe, DÜSOL and SESAM).

The energy requirement of the thermochemical air separation is theoretically at the thermodynamic limit of the corresponding separation process and is therefore far below the energy requirement of CO₂ cleavage. In practice, however, the heat energy required for the reduction cannot be recovered completely.

In most cases, the energy for the operation of space probes on planet Mars and in the outer solar system is produced by so-called radionuclid batteries. Thus, the decay heat of a radionuclide, usually ²³⁸Pu, is utilized for producing electric power by a thermoelectric generator. The efficiency of such a generator is in the range of one-digit percent, but the electricity is generated very reliably possible over many years or decades, since the plutonium isotope ²³⁸Pu, for example, has a half-life of 87,7 years.

For oxygen production on Mars in preparation of a manned mission with an up-scaled follow-up instrument of MOXIE, a nuclear energy source with an eletric power of 25-30 kW could be employed [https://www.popularmechanics.com/space/moon-mars/a35512066/nasa-moxie-perseverance-rover]. Considering the typical efficiency of thermoelectric generators, about 300 to 400 kW of heat energy would be produced by the decay heat of the radioactive plutonium isotope, which corresponds to a mass of 500-700 kg of ²³⁸Pu for a heat release of about 0.57 W/g [Miotla, Dennis, Apr. 21, 2008, “Assessement of Plutonium-238 production alternatives”, https://www.energy.gov/sites/prod/files/NEGTNONEAC_PU-238_042108.pdf].

Alternatively, solar energy could be employed, wherein solar panels having a surface area of far above 1000 m² would have to be employed because of the radiation power from the sun, which is about half of the value on earth, and the limitation of power generation due to the different times of the day (10 m² per kWₚₑₐₖ on earth, 20 m² per kWₚₑₐₖ on Mars, the average power per Martian day being only a fraction of the peak power), in order to achieve an average power of 25-30 kW, assuming that the photovoltaic cells can be kept dust-free.

In their “Kilopower” project, the NASA is currently testing the use of nuclear reactors as an alternative source of electric power. In this way, a higher power can be achieved more easily, and ²³⁸Pu is not required. However, currently, the use of highly enriched uranium-235 (HEU) is planned for this, and the generation of 25-30 kW of electric power requires several reactors [NASA website, “Powering Up NASA's Human Reach for the Red Planet”, retrieved on Apr. 26, 2021, https://www.nasa.gov/directorates/spacetech/feature/Powering_Up_NASA_Human_Reach_for_the_Red_Planet].

Thus, the currently planned oxygen generation on planet Mars by the cleavage of CO₂ by electrolysis (NASA) has several drawbacks:

1. High demand of electric energy

The estimated demand of 25-30 kW of electric energy can be met by radionucleide batteries only if considerable amounts of ²³⁸Pu are employed. Radionucleide batteries with such a high power have not been employed yet either on earth or in space missions. According to the prior art, 500-700 kg of plutonium would be currently required to meet the need for energy. Considering the power decline by partial decay until the arrival on Mars and the need for power reserves, accordingly, about one metric ton of ²³⁸PuO₂ (plutonium (IV) oxide) would be required. Even if Sterling generators were employed as an alternative to thermoelectric generators, an amount of plutonium in the lower three-digit kilogram range would still be necessary for providing the necessary power.

Such amounts of plutonium-238 can currently be produced nowhere on earth in acceptable time scales. In the procurement of this plutonium isotope, there currently is a high dependency on Russia, while production in the U.S.A. has been devised, but only up to 5 kg of ²³⁸Pu per year [Miotla, Dennis, Apr. 21, 2008, “Assessement of Plutonium-238 production alternatives”, https://www.energy.gov/sites/prod/files/NEGTN0NEAC_PU-238_042108.pdf]. In addition, the production of ²³⁸Pu is very expensive and energy-consuming.

Further, the radioactivity and toxicity of plutonium require an effective shielding of the radiation, and heat shields that prevent significant amounts of plutonium from being released to the environment in the case of an unplanned crash of the spacecraft on earth.

All in all, the provision of such amounts of electric power from radionuclide batteries on Mars does not appear to be feasible in the near future for reasons of production capacities, political and cost reasons.

The utilization of nuclear reactors or solar plants appears to be more realistic in comparison, even though the weight of a corresponding total facility still appears very high, and the transport to Mars is thus difficult to achieve.

2. High weight and volume

A sufficiently sized plant for oxygen production by electrochemical CO₂ cleavage would have a mass of about 1 metric ton and a volume of about 1 m³ [M. Hecht et al., loc. cit.]. This does not yet include the generator for producing the necessary electric power. Since the transport of material to the Martian surface is very complicated and expensive, its weight and volume should be minimized as much as possible.

3. Complicated facility design

The solid-state electrolytic decomposition of CO₂ as planned according to the prior art requires rather sensitive components that are complicated to construct. In particular, the elimination of dust from the Martian atmosphere is critical in order to avoid damage to the facility [M. Hecht et al., loc. cit.]. In an operation under real conditions of the Martian surface that takes several months, there is a high risk of failure.

The currently planned oxygen production on planet Mars by the electrolysis of water (SpaceX) has comparable drawbacks. Here too, there is a large need for electric power, which results in the above mentioned drawbacks. The plant for the electrolysis of water is also large, heavy, and complicated. However, as compared to the earlier mentioned option, there is a possibility of producing methan as a fuel from the produced hydrogen directly in a Sabatier process. Nevertheless, large and expensive plants are required, which additionally have a high risk of failure.

### BRIEF SUMMARY OF THE INVENTION

Therefore, there is a need for a process for providing oxygen in an extraterrestrial atmosphere that avoids the drawbacks resulting from the prior art as much as possible. Surprisingly, it has been found that a thermochemical cycle enables effective working even at low oxygen partial pressures, and oxygen can be recovered in this way. Therefore, in a first embodiment, the object of the present invention is achieved by a process for concentrating existing oxygen in extraterrestrial atmospheres by using a thermochemical cycle, wherein an oxygen partial pressure of 10⁻⁴ bar or less prevails in the atmosphere, characterized by comprising the following steps:
a. generating a gas flow in the atmosphere, wherein said gas flow has an oxygen partial pressure of 10⁻⁴ bar or less,
b. providing a redox material in the form of a perovskite in its reduced form ABO_{3-δ1}, and oxidizing it to ABO_{3-δ2} (where δ1>δ2) by bringing it into contact with the gas flow at a temperature T₁,
c. heating of the redox material ABO₃, which is in its oxidized state, to a temperature T₂, whereby oxygen (O₂) is cleaved from the redox material, and said redox material is converted to its reduced form ABO_{3-δ1} again,
   where T₁<T₂, and
d. again subjecting the redox material ABO_{3-δ} obtained in step c) to step b), wherein the cooling of the redox material from T₂ to T₁ is effected by the gas flow.

Thus, the present invention enables existing oxygen in extraterrestrial atmospheres to be concentrated, in which the concentration of oxygen and thus the oxygen partial pressure are significantly lower than they are on earth. Surprisingly, it has been found that a thermochemical cycle is able to effectively produce oxygen even at oxygen partial pressures of 10⁻⁴ bar or less. Even rates according to which up to 2.25 kg of oxygen per hour can be recovered from a corresponding atmosphere with a low oxygen partial pressure can be realized. The process according to the invention can be applied, in particular, to Mars missions, which are currently being planned by different space agencies. It makes use of the fact that the affinity for oxygen binding of multivalent metal oxides depends on the temperature and oxygen partial pressure.

### BRIEF DESCRIPTION OF THE DRAWINGS

The present invention is illustrated and described herein with reference to the drawings, in which any like reference numbers denote like method steps and/or system components, respectively and in which:

FIG. 1 is graph illustrating oxygen intake effected under the oxygen partial pressure of an extraterrestrial atmosphere; and

FIG. 2 is a device for concentrating oxygen in extraterrestrial atmospheres.

### DETAILED DESCRIPTION OF THE INVENTION

According to the invention, perovskites of the general structure ABO₃ are employed as the redox material. A “redox material” within the meaning of the present invention is a material that has both an oxidized and a reduced state in which it is stable. The redox material is in its reduced form ABO_{3-δ1} at first. When it is brought into contact with oxygen, an oxidation occurs. Oxygen is bound thereby, wherein this need not necessarily be stoichiometrically The thus obtained oxidized form of the redox material is designated as ABO₃.

Thus, the following reactions take place during an oxidation or reduction:

Reduction ABO_{3-δ2}→ABO_{3-δ1}+δ/2O₂

Oxidation ABO_{3-δ1}+δ/2O₂→ABO_{3-δ2}

The reduction takes place at the temperature T₂, and the oxidation takes place at the temperature T₁, where T₂>T₁. The oxidation of the perovskite may be complete or partial. This is represented by the indices δ1 and δ2, where δ1>δ2.

Thus, by setting the temperature, the redox material can be converted from its oxidized form back to its reduced form. Oxygen is released thereby. Surprisingly, it has been found that this reaction, which has already been described for the decomposition of air in the earth's atmosphere, can also be performed successfully at extremely low oxygen partial pressures of 10⁻⁴ bar or less.

Thus, the process according to the invention is also applicable on Mars, for example. An average oxygen partial pressure for the Martian atmosphere can be indicated to be about 8.4·10⁻⁶ bar. Even such an oxygen partial pressure is sufficient to enable the concentrating of oxygen by the process according to the invention.

Especially with atmospheres from which the gas flow is obtained in step a) according to the invention, which is contacted with the redox material, that have a high content of carbon dioxide CO₂, it is preferred for the redox material to be selected in such a way that it does not form any stable carbonates, especially no carbonates that are stable at the temperatures at which the redox material is reduced or oxidized. Thus, preferably, the reaction of the redox material with CO₂ is not supposed to yield carbonates that are stable at temperatures of higher than 200° C., especially higher than 250° C. If the redox material reacts with CO₂ to a carbonate that will not decompose again at higher temperatures, it is no longer available for the reaction with oxygen, i.e., it can no longer be oxidized and reduced.

In principle, the redox material has to meet the following boundary conditions for an effective process to be possible, by which sufficient amounts of oxygen can be recovered even at low oxygen partial pressures:
i) sufficiently fast oxidation kinetics,
ii) Δδ≥0.1 for a given temperature difference ΔT (temperature difference between T₁ and T₂), wherein Δδ is the difference between δ1 and δ2, and
ii) no formation of stable carbonates.

It has been found that perovskites are basically capable of meeting these three conditions. A suitable selection of perovskites can substantially avoid the formation of carbonates, especially of carbonates that are stable at temperatures above 200° C.

In the redox material ABO₃, A and B are metals, especially different ones, which are not alkali metals and/or alkaline earth metals, in particular. Alkali metals and alkaline earth metals tend to form stable carbonates, even if they are incorporated into a perovskite structure. Therefore, the perovskites used according to the invention are preferably free from alkali metals and alkaline earth metals. In particular, A is not an alkali metal or alkaline earth metal.

In particular, A in the perovskite is selected from lanthanoids or actinoids, A is especially a lanthanoid, and more preferably, A is selected from Sm, Eu, Gd, more preferably, A is Eu.

B is preferably a transition metal, especially a transition metal from the 4th period, preferably from Groups 9 to 12, more preferably selected from Cu, Ni, Co, or Fe.

Suitable redox materials include, for example, EuNiO₃, SmLaNiO₆, or SmₓLa_{y}CuₘCOₙO₃ (with x=0.25 . . . 0.5, y=1−x, m=0.0 . . . 0.25, n=1−m).

In order to enable sufficient oxygen affinity and at the same time minimize the energy demand for reduction, the redox material preferably has a redox enthalpy ΔH of 60-140 kJ/mol of O, especially 70-90 kJ/mol of O, preferably 70-75 kJ/mol of O. Thus, the redox enthalpy is expressed in kJ/(mol of O) according to the invention. Larger redox enthalpies are desirable in principle. However, when the values are too high, more energy has to be invested, whereby the process as a whole would have a lower energy efficiency. Therefore, the redox enthalpy is preferably not more than 140 kJ/mol.

The process according to the invention includes a step of oxidizing the redox material, and a step of reducing the redox material. During the oxidation, the redox material is transferred from its reduced state ABO_{3-δ} to its oxidized state ABO₃. This is preferably affected at a temperature within a range of from 200° C. to 700° C., preferably from 250° C. to 600° C., especially from 300° C. to 550° C., more preferably from 350° C. to 500° C., especially preferably from 400° C. to 450° C. At such temperatures, oxidation can take place effectively, because the affinity for oxygen of the reduced material is sufficiently high at such temperatures to enable effective oxygen uptake, but at the same time, the reaction kinetics is favorable, so that the reaction takes place within a few seconds.

The reduction, i.e., the conversion of the redox material from ABO₃ to ABO_{3-δ} and thus the release and recovery of oxygen, takes place at a temperature T₂, which is above the temperature T₁ at which the oxidation takes place. The reduction and thus the release of oxygen preferably take place at a temperature within a range of from 400° C. to 1200° C., preferably from 500° C. to 1000° C., especially from 550° C. to 950° C., preferably at a temperature from 600° C. to 900° C., especially preferably at a temperature from 700° C. to 800° C. At such temperatures, an effective cleavage of oxygen from the redox material can take place.

In addition to the already mentioned aspects, perovskites further have the advantage that the volume variations in the change between the temperature ranges T₁ and T₂ are low. Therefore, the stress on the material is low, so that perovskites are stable over a long period of time, and the process according to the invention can be performed over a high number of cycles, without the redox material having to be exchanged.

The energy for heating the redox material as required for the process according to the invention is preferably provided by nuclear energy or from the waste heat of exothermic chemical processes. Thus, heat energy can be utilized directly without converting this heat energy to electric energy at first, which would then have to be converted back to heat energy again. What is especially relevant is the cyclic heating of the redox material. When several 1000 cycles are assumed, the energy required for the initial heating can be neglected.

The energy required for the thermochemical cycle may also be obtained from solar energy. However, this is dependent on the position of the planet in the solar system, i.e., on whether sufficient solar energy is available, for example, to provide sufficient heat by means of concentrated solar radiation.

More preferably, the energy required for the thermochemical cycle is provided by means of nuclear energy. This has the advantage that the heat generated in the radioactive decay can be utilized directly. In a particularly preferred embodiment, a radioactive material is provided together with said redox material. This means that a material that produces radioactive decay heat is combined with a redox material, for example, a perovskite. Thus, the decay heat is produced immediately at the place where it is needed. A transport of heat is not required. Therefore, the heat loss is very low, and the process enables the immediate utilization of heat, without having to convert it to electric power first. The direct utilization of heat and an immediate heat transfer without great losses enables an effective process, for which little material and thus little weight has to be transported into the extraterrestrial space.

In a preferred embodiment, the heat required for heating the redox material from temperature T1 to temperature T2 is provided by nuclear energy, wherein ²³⁸Pu, ⁹⁰Sr and/or ²⁴⁴Cm, in particular, are used as radioisotopes. The radionuclides can be provided in the form of their oxides, such as ²³⁸PuO₂, ⁹⁰SrO, or ²⁴⁴Cm₂O₃, for example. ²⁴⁴Cu₂O₃ could also be used.

²³⁸Pu has the advantage that it is subject to a decay almost exclusively, and n or y emissions virtually do not occur. The neutrons are released because of (α, n) reactions. Since ²³⁸Pu is not a by-product of nuclear power plants, its availability is low.

⁹⁰Sr emits β radiation (⁹⁰Sr→⁹⁰Y→⁹⁰Z). Since bremsstrahlung is emitted, a good shielding must be ensured. However, the availability is good because ⁹⁰Sr is obtained in nuclear power plants.

²⁴⁴Cm has a high energy density and also emits a-radiation, so that shielding is easily possible. The neutron emission is about 45 times as high as that of ²³⁸Pu, so that an improved shielding is necessary in this comparison. Since ²⁴⁴Cm is also obtained in nuclear power plants, this nuclide is readily available.

According to the invention, it is possible to mix perovskite and plutonium oxide particles together. Also, mixing powders made of both materials is possible according to the invention. In this case, in particular, it is desirable to melt the two powders at high temperatures, because handling a powder in extraterrestrial space can be difficult.

Irrespective of the exact kind of mixing, the radioactive material will heat the redox material directly, so that the heat losses are clearly reduced, and virtually non-existing.

In an alternative embodiment, the material that produces radioactive decay heat immediately serves as the redox material. Thus, for example, plutonium or other radioactive elements can be integrated into a perovskite structure. In this embodiment, the redox material heats itself independently by the decay heat. Here too, an immediate heating of the redox material is ensured, without a loss of heat taking place, for example, from transports or transfers.

The process according to the invention not only requires the possibility of heating the redox material. After the reduction is complete, the redox material must be cooled down to temperature T₁ again in order to be available again in the cycle. According to the invention, the cooling of the redox material is preferably effected by producing a gas flow in step a) of the process according to the invention. The latter cools down the redox material to the desired temperature in step b). Extraterrestrial atmospheres usually have a temperature below the temperature of the earth's atmosphere, so that effective cooling is possible, in particular, on Mars (average of about −60° C.).

The generation of the gas flow can be effected, for example, with a fan or a pump. The faster the gas flow, i.e., the faster the speed of the gas flow, the more gas of the corresponding extraterrestrial atmosphere gets into contact with the redox material per unit of time. The oxidation can then be designed effectively. It is especially effective from an energetic point of view if the gas speed does not exceed a Mach number of 0.30.

For the redox material to come into contact with the gas flow effectively, it is preferably in a form that can be flowed through by the gas flow. This is possible, for example, when the redox material is in the form of granules, which are charged into a suitable container in the form of a packing, which is then flowed through by the current of gas. According to the invention, it is also provided that the redox material is in the form of a solid having channels or tubes, through which the gas then flows, so that the surface of the redox material comes into contact with the gas flow as completely as possible. A grid or honeycomb structure is also conceivable here.

The generation of the gas flow results in the redox material being cooled. At the same time, however, the gas flow itself is warmed up. This enables the utilization of this warmed-up gas flow for using this obtained energy to produce electric power. In a preferred embodiment, therefore, the gas, which is in a warmed-up state after the reaction with the redox material, is utilized for producing electric power.

After the cleavage of the oxygen from the redox material, i.e., after the reduction of the redox material is complete, the pumped-off mixture of oxygen and possibly other gases is preferably precompressed. This enables impurities, such as CO₂, to be liquefied. These may then be separated from the oxygen, whereby another purification of the oxygen is effected.

Thus, the present application describes for the first time the use of a thermochemical cycle for producing oxygen in extraterrestrial atmospheres. Preferably, nuclear energy is used for obtaining the required heat, because the latter is available for a long period of time and can be employed locally on the redox material itself, whereby heat losses are minimized.

In principle, the process according to the invention can be performed in a continuous or in a batch procedure. In a continuous procedure, there are preferably two separate reactors, wherein the oxidation of the redox material takes place in one reactor, and the reduction thereof takes place in a different reactor. The redox material is then transported from one reactor to the other.

In a discontinuous procedure, the oxidation and reduction of the redox material take place in one reactor. The reactor has at least one inlet and outlet opening, wherein the gas flow enters through the inlet opening into the reactor, and leaves it through the outlet opening. After the oxidation of the redox material has taken place inside the reactor, the inlet and outlet openings are closed, so that the temperature inside the reactor rises, and a temperature level is reached at which the reduction of the redox material takes place. After the reduction is complete, the inlet and outlet openings are reopened. A current of gas flows through the reactor, so that a renewed oxidation of the redox material takes place.

The duration of the reduction or oxidation is about 5 minutes to 45 minutes, especially from 10 minutes to 30 minutes. In a continuous operation, the duration can be adjusted through the transport of the redox material. In a discontinuous operation, this is controlled by the duration of the open/closed states of the reactor.

The present application thus provides a process and a possible device for producing oxygen from the atmosphere of Mars or other extraterrestrial atmospheres of other celestial bodies by a concentration process using a thermochemical redox material. From a thermodynamic point of view, the production of oxygen by concentrating requires significantly less energy with the process according to the invention as compared to the production thereof using CO₂ cleavage or electrolysis. In addition, the major part of the required energy can be provided in the form of heat energy, which acts directly locally at the redox material in a preferred embodiment.

The use of perovskites, in particular, as a redox material enables oxygen to be effectively concentrated, since they can be oxidized below the average oxygen partial pressure of extraterrestrial atmospheres at the usual temperatures.

Perovskite having a redox enthalpy of around 120 kJ/mol of oxygen are particularly suitable. In addition, these enable as many redox cycles as possible to take place within one hour, in order to thus make oxygen production effective.

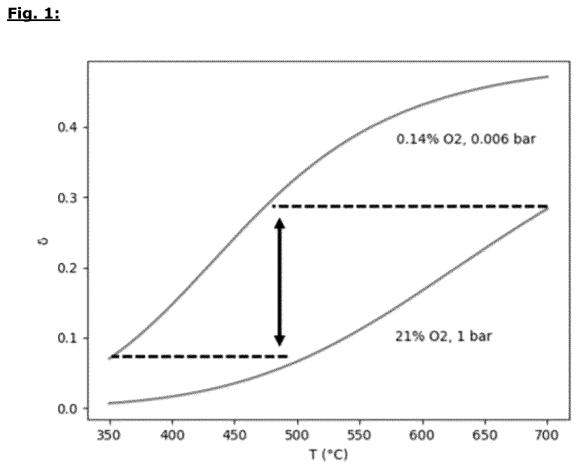

The redox reaction ideally proceeds in two steps. FIG. 1 models the thermodynamic equilibrium of a perovskite having a redox enthalpy of 120 kJ/mol of oxygen in an exemplary way, wherein the molar entropy of oxygen release and the configuration entropy were taken into account for the entropic part, and the change of vibration entropy was neglected.

In FIG. 1, the oxidation and thus oxygen intake is effected under the oxygen partial pressure of the extraterrestrial atmosphere, such as the Martian atmosphere, while the reduction, i.e., the release of pure oxygen, is effected at an oxygen partial pressure of 21% as an example, which corresponds to the concentration of oxygen in the earth's atmosphere. For a correspondingly increased temperature or other thermodynamic properties of the redox material, however, the oxygen may be released under significantly higher pressures. The present application mentions the Martian atmosphere in an exemplary way as a possible extraterrestrial atmosphere, but without the application being limited thereto.

The redox reaction produces a temperature-dependent and partial pressure-dependent equilibrium between gaseous oxygen and oxygen stored in redox material. The elimination of oxygen from the crystal lattice of the redox material leaves oxygen vacancies. The resulting non-stoichiometry is represented by the value δ, which is shown on the y axis of FIG. 1.

The heat necessary for the reaction is preferably provided by nuclear processes, because nuclear energy sources are planned at first anyway for the extraterrestrial energy supply, for example, on Mars. Alternatively, waste heat from other processes or heat from concentrating solar plants could also be employed.

The electric power necessary for further parts of the apparatus (pumps, valves, and electronics) corresponds to only a smaller part of the heat energy that occurs, and therefore it can be preferably obtained from the waste heat of the chemical reaction through thermoelectric generators or Sterling systems.

The direct utilization of heat energy for the chemical reaction offers the advantage over the prior art that the inefficient conversion to electric energy is omitted, and thus the necessary thermal power of the energy source is significantly reduced when nuclear energy is used.

In the case where nuclear reactors are used, these may have a significantly smaller size, and in the case where the heat from the decay of plutonium-238 (or other isotopes of plutonium or other suitable elements) is used, there is a significantly lower necessary amount of plutonium. In both cases, there is a clear reduction of the mass to be transported to Mars, and a clear reduction of the necessary radioactive material, and thus cost advantages, and an easier realizability under political aspects.

The heat necessary for the reaction is seen from the following consideration:

The oxidation of the redox material takes place at the temperature T₁ (typically 200° C. to 750° C., in FIG. 1: 350° C.), and the reduction takes place at the temperature T₂ (typically 400° C. to 1200° C., in FIG. 1: 700° C.). To put it more simply, it is to be considered that the temperature never sinks below the value T₁. Since the process proceeds as a cycle between the two temperatures T₁ and T₂, heating the material to the temperature T₁ is required only at the first start of the process, which can be neglected in the energy balance in view of thousands or ten thousands of redox cycles.

The heat energy ΔQₘ necessary for heating the material per cycle can be seen from

ΔQₘ=C·m·ΔT

or taking the molar heat capacity c into account:

ΔQₘ=c·n·ΔT

ΔQₘ=c·M/m·ΔT

For the sake of simplicity, the molar heat capacity c can be assumed according to the Debye model to be 125 J/mol·K (3·N·R, wherein N=5 for ABO₃ perovskites). According to the Example in FIG. 1, the temperature difference is 350 K.

The target production rate of an oxygen generator for the preparation of a manned Mars mission is at least 2 kg of oxygen per hour. Thus, 17.5 t of oxygen can be produced within one earth year, and the 25 t of oxygen calculated for the return flight and the life support systems can accordingly be produced within little more than 17 months.

Assuming that about 4 redox cycles per hour can be performed (which is realistic because of the redox kinetics of the perovskites employed, see Vieten et al., “Redox Behavior of Solid Solutions in the SrFe₁₋ₓCuₓO_{3-δ} System for Application in Thermochemical Oxygen Storage and Air Separation”, Energy Technology, 2019), a necessary production rate of 500 g of oxygen per cycle results.

The reaction is described by

ABO₃→ABO_{3-δ}+δ/2O₂

Let the reachable change of non-stoichiometry Δδ be 0.15 (see FIG. 1, conservative assumption). Then, a need of 208 mol or perovskite redox material for the production of 500 g (=15.6 moles) of oxygen results from the reaction equation.

Then, it results that

ΔQₘ=125 Jmol⁻¹K⁻¹·208 mol·350 K

ΔQₘ=9.10 MJ=2.53 kWh

This is just the heat necessary for heating the material. The necessary reaction heat ΔQᵣ for the (endothermic) reduction results from the redox enthalpy of the material per mol of O:

ΔQᵣ=ΔH_{O}·Δδ·n

With Δδ=0.15, a redox enthalpy ΔH_{O}=120 kJ/(mol O) and n=208 mol, one gets

ΔQᵣ=3.74 MJ=1.04 kWh

Thus, all in all, what results is a heat demand of 3.6 kWh per cycle, and an average demand of heat power for the overall process of 14.3 kW. This is significantly below the 25-30 kW of electric power that is necessary in a system similar to MOXIE according to the prior art. Since a nuclear system must provide 100-400 kW of thermal power for providing 25-30 kW of electric power, the need for heat energy of the system presented here per kg of oxygen is about one order of magnitude below that of the prior art. This results in the described advantages in the weight of the plant and the necessary amount of radioactive material when utilizing nuclear energy as a source of heat.

Both ΔQm and ΔQr can theoretically be recovered in the re-oxidation of the material, in which a small difference remains from the entropy term of the redox reaction and the temperature dependence of the redox enthalpy, which corresponds to the thermodynamically necessary minimum work for gas separation. If an efficient recovery of the heat employed for reduction should be possible, an even significantly lower need for energy is theoretically possible. However, electric power for the operation of pumps and electronics is also required in the proposed apparatus. It could be generated by thermoelectric generators or a Sterling apparatus from the waste heat of the reaction. Therefore, the usable amount of waste heat from the chemical reaction is limited.

The amount of 200-250 mol of perovskite as a redox material (208 mol in the above exemplary calculation) corresponds to about 50-63 kg of redox material for a molar mass of 250 g/mol (LaCuO₃), or 85-106 kg of redox material for a molar mass of 425 g/mol (CsPuO₃). Thus, as compared to the prior art (Scale-up MOXIE, about 1 t), a mass of the oxygen-producing reaction chamber that is lower by about one order of magnitude is obtained. This leads to significant cost savings in the transport to Mars or other planets.

The electric power necessary for pumps and compression results from the following consideration:

The recovery of 500 g of oxygen per cycle requires the throughput of a volume of 350 I of pure oxygen at STP (according to molar normal volume, “standard temperature and pressure”), or 41700 m³ at the same temperature and 8,4·10⁻⁶ bar. For the average temperature of the Martian atmosphere of 210 K, a volume of 32,100 m³ is obtained. For an oxidation time of 10 min per cycle, a necessary throughput of the fan for putting through the Martian atmosphere of above 190,000 m³/h results. This value appears to be very high, but such a throughput can be achieved with a moderate input of energy in the case of planet Mars, since the Martian atmosphere, having a density of only 0.017 kg/m³, counters this throughput with very little resistance. The exact energy requirement depends on the construction of the redox material and the reaction chamber, through which the planet's atmosphere is pumped, whereby the corresponding pressure loss can be calculated. The necessary minimum pumping power is then obtained from the hydraulic power P=QΔp/3600, wherein P represents the power in kW, Q indicates the flow rate in m³/h, and Δp corresponds to the pressure loss in kPa. For a pressure loss of 0.5 mbar (0.05 kPa), which appears to be realistic in a first estimation, this corresponds to a power of 2.7 kW. If the oxidation reaction is performed more slowly, the necessary flow rate and thus also the pressure loss and the necessary pumping power decrease. However, the amount of necessary redox material will also increase thereby. Thus, ultimately, this is an optimization problem.

For the compression of the oxygen obtained per cycle to a pressure of 200 bar, under the idealized assumption of an isothermic compression (W=nRT In(p1/p0)), a work of 13.2 kJ/mol of oxygen is to be delivered, which corresponds to a work of about 55 Wh per cycle with 15.6 mol of oxygen. For a compression over a period of 5 min (estimated duration of the reduction step), a (temporally available) power of 0.67 kW would be necessary. The real energy requirement is significantly higher because of the fact that the efficiency is not 100%, and because of the non isothermic compression. However, liquefaction methods that can do without such a strong compression are also conceivable.

Thus, in contrast to the prior art, the energy necessary for the chemical reaction can be provided directly as heat energy according to the invention. This reduces the need for primary heat energy by one order of magnitude. If nuclear energy is used (as currently planned by the NASA), the necessary amount of radioactive material is clearly reduced.

Considering the overall necessary pumping and compressing power, it becomes clear that the estimated requirement of electric energy for the operation of pumps and compressors on the order of 3 KW can be recovered from the waste heat of the thermochemical reaction.

Further shown in an exemplary way is a device for concentrating existing oxygen in extraterrestrial atmospheres, in which the process according to the invention can be performed in continuous operation. Such a device includes:
a. a reaction chamber, which is filled with the redox material at least partially, preferably completely;
b. an inlet, which can seal the reaction chamber hermetically from the environment by means of a closure;
c. an outlet, which can seal the reaction chamber hermetically from the environment by means of a closure;
d. a fan for generating a gas flow, wherein the fan is provided in the range of the inlet closure, so that a gas flow is produced that flows from the inlet towards the reaction chamber and then on towards the outlet; and
e. a compressor with an expansion turbine.

Thus, the device enables the process according to the invention to be performed. The fan produces the gas flow, which provides for an effective contact of the gas flow with the redox material, and at the same time is also able to cool it. Therefore, the fan is oriented in such a way that the gas flow flows through the inlet, subsequently into and through the reaction chamber towards the outlet.

The device may further have a backing pump and a separation means for separating gas from liquid. The backing pump and separation means are spatially arranged between the outlet and the compressor. The compressor with expansion turbine provides for liquefaction of the oxygen. A backing pump can achieve a first compression of the recovered oxygen. Impurities, such as CO₂ or noble gases, are thereby liquefied and can then be removed in the separation means.

Further, the device may include a generator, which can generate electric power for the operation of the compressor and of the backing pump, which is optionally present.

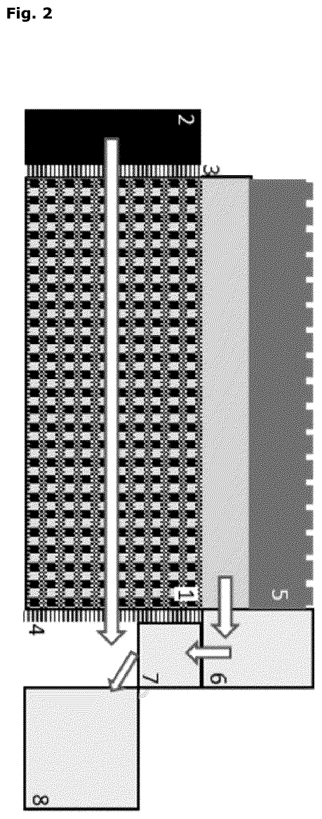

A suitable device is schematically shown in FIG. 2. Such a device includes, for example:
1. a reaction chamber filled with redox material or redox composite material
2. a fan
3. an inlet with a closure
4. an outlet with a closure
5. a generator
6. a backing pump
7. a gas/liquid separating means
8. a compressor with an expansion turbine.

In one device, the redox material or redox composite material is provided in a reaction chamber (1). This is done in such a way that a gas flow can flow through it. In order to obtain an effective heat generation, preferably, about half to two thirds of the mass of the redox material is to be oriented towards a radioactive material.

The radioactive decay of plutonium, for example, results in a permanently emitted heat power of about 30 kW.

The reaction chamber (1) has two opposing ends/openings. These are referred to as the inlet (3) and the outlet (4) in the direction of flow of the gas flow. In the area of the inlet (3), there is a fan (2) or a comparable means for producing a gas flow. This provides for a sufficient flow rate of the extraterrestrial atmosphere, for example, the Martian atmosphere, through the redox material in the reaction chamber (1). This ensures that sufficiently oxygen from the atmosphere is available for oxidizing the redox material.

Preferably, there are suitable closures at the inlet (3) and outlet (4) of the reaction chamber (1). These enable an essentially gas-tight sealing of the reaction chamber (1) filled with redox material or redox composite material towards the atmosphere.

Preferably, the device further includes a generator (5), for example, a thermoelectric generator. From the temperature difference between the waste heat of the reaction or the radioactive decay heat and the Martian atmosphere, electric energy for the operation of pumps and compressors can be produced.

With a backing pump (6), the gas pumped out of the reaction chamber can be compressed at first to a pressure of about 40 bar, whereby remaining carbon dioxide is liquefied. The liquefied carbon dioxide is drained in a separation means (7), while the gas phase, i.e., the oxygen, remains inside the apparatus.

In the main compressor (8), the gas phase is compressed to a pressure of about 200 bar, and then released through a turbine, which recovers part of the compression energy through a generator. The pressure release cools the gas down, whereby liquid oxygen is formed as an end product in high purity. Only small amounts of nitrogen or light noble gases can be present as impurities. However, their concentrations are so low to be irrelevant.

The operation of the device proceeds in cycles. The redox material is heated by the release of heat. At the beginning, the inlet and outlet valves are closed.

Reduction of the redox material releases oxygen. Once the previously defined maximum temperature is reached, the pump (6) is activated, which removes and compresses the oxygen and any residual gases present in the reaction chamber (1). After the removal of oxygen, the closures, for example, valves at the inlet (2) and outlet (4), are opened, and the fan (2) is activated. The gas flow through the fan provides for cooling of the redox material inside the reaction chamber (1), and oxidizes it. After the oxidation of the redox material is complete and a minimum temperature has been reached, the fan (2) is deactivated, and the closures, for example, valves at the inlet (2) and outlet (4), are closed, so that the cycle can start anew.

1. A process for concentrating existing oxygen in extraterrestrial atmospheres by using a thermochemical cycle, wherein an oxygen partial pressure of 10⁻⁴ bar or less prevails in the atmosphere, comprising the following steps:
a. generating a gas flow in the atmosphere, wherein said gas flow has an oxygen partial pressure of 10⁻⁴ bar or less,
b. providing a redox material in the form of a perovskite in its reduced form ABO_{3-δ1}, and oxidizing it to ABO_{3-δ2} (where δ1>δ2) by bringing it into contact with the gas föpw at a temperature T₁,
c. heating of the redox material ABO₃, which is in its oxidized state, to a temperature T₂, whereby oxygen (O₂) is cleaved from the redox material, and said redox material is converted to its reduced form ABO_{3-δ1} again,
where T₁<T₂, and
d. again subjecting the redox material ABO_{3-δ} obtained in step c) to step b), wherein the cooling of the redox material from T₂ to T₁ is effected by the gas flow.

2. The process according to claim 1, characterized in that the oxidation of the redox material from ABO_{3-δ} to ABO₃ takes place at a temperature T₁ which is within a range of from 200° C. to 750° C., preferably from 250° C. to 700° C., especially from 300° C. to 600° C.

3. The process according to claim 1 or 2, characterized in that the reduction of the redox material from ABO to ABO_{3-δ} and thus the production of oxygen takes place at a temperature T₂ which is within a range of from 400° C. to 1200° C., especially from 450° C. to 1100° C., preferably from 500° C. to 1000° C., more preferably from 550° C. to 900° C.

4. The process according to one or more of claims 1 to 3, characterized in that energy required for the thermochemical cycle, especially the energy for heating the redox material to temperature T₂, is provided directly in the form of heat, especially from nuclear energy, or from waste heat of exothermic chemical reactions, or from solar energy.

5. The process according to claim 4, characterized in that the heat is provided from nuclear energy, wherein ²³⁸Pu, ⁹⁰Sr and/or ²⁴⁴Cm, in particular, are used as radioisotopes.

6. The process according to claim 5, characterized in that the required energy is provided from nuclear energy, wherein the radioisotopes are mixed with the redox material.

7. The process according to claim 4 or 5, characterized in that the required energy is provided from nuclear energy, wherein the redox material is itself radioactive.

8. The process according to one or more of claims 1 to 7, characterized in that said redox material is a perovskite ABO₃, wherein A and B are different metals, which are in particular not alkali metals and/or alkaline earth metals.

9. The process according to one or more of claims 1 to 8, characterized in that A in perovskite ABO₃ is selected from lanthanoids or actinoids, especially lanthanoids.

10. The process according to one or more of claims 1 to 9, characterized in that B in perovskite ABO₃ is a transition metal, especially a transition metal from the 4th period, preferably from Groups 9 to 12, more preferably selected from Cu, Ni, Co, or Fe.

11. The process according to one or more of claims 1 to 10, characterized in that the redox material has a redox enthalpy ΔH of 60-140 kJ/mol of O, especially 70-90 kJ/mol of O, preferably 70-75 kJ/mol of O.

12. The process according to one or more of claims 1 to 10, characterized in that it is performed in a reactor, in which the redox material as a solid is in the form of a lattice, or has channels or tubes, so that the surface of the redox material comes into contact with the gas flow as completely as possible.

13. The process according to one or more of claims 1 to 11, characterized in that the reactor is opened at an inlet and an outlet for being flowed through by the gas flow, which outlets are closed for the oxidation.

14. The process according to one or more of claims 1 to 12, characterized in that the gas flow, which is in a warmed-up state after the reaction with the redox material, is utilized for producing electric power.

15. The process according to claim 13, characterized in that electric power is used for producing the gas flow.

16. The process according to one or more of claims 1 to 15, characterized in that the recovered oxygen is compressed and stored, in particular, as liquid oxygen.

17. Use of a thermochemical cycle for producing oxygen in extraterrestrial atmospheres, in which a gas flow with an oxygen partial pressure of 10⁻⁴ bar or less is contacted with a redox material in its reduced form ABO_{3-δ}, whereby said redox material is oxidized at least partially to ABO₃, and in a further step, the oxygen is removed again from the redox material in its oxidized form ABO₃, whereby oxygen (O₂) is obtained.
